(19) United States
(12) Patent Application Publication
(10) Pub. No.: US 2004/0047368 A1
(43) Pub. Date: Mar. 11, 2004

(54) Frame synchronization for OFDM systems

(76) Inventor: Jin Biao Xu, Beijing (CN)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/229,682

(22) Filed: Aug. 28, 2002

(51) Int. Cl. H04J 3/06

(52) U.S. Cl. 370/509; 370/208

(57) ABSTRACT

Frame synchronization in an OFDM system involves calculating a frame synchronization result as a complementary weighted summation of (i) a matched filtered technique, and (ii) an autocorrelation technique. A preamble of ten short training symbols (five predetermined symbols, repeated twice) is transmitted in an OFDM system to provide a basis for performing the matched filter and autocorrelation techniques. The complementary weighted summation is performed using parameters α and (1-α), in which α belongs to the set of numbers between zero and one. Desirably, α is in the range 0.5 to 0.9. Improved (or at least equivalent) synchronization failure rate and bit error rate performance results, compared with either the matched filter technique and the autocorrelation technique alone.

### FIELD OF THE INVENTION

The present invention relates to a frame synchronization in multicarrier modulation system. In particular, the present invention relates to improved algorithmic techniques for synchronizing frames in multicarrier modulation systems, such as orthogonal frequency divisional multiplexing (OFDM) systems.

### BACKGROUND

There is increasing demand for high bandwidth wireless systems having indicative data rates of greater than 20 Mbit/s. In such systems, however, severe degradation results from intersymbol interference (ISI) caused by multipath propagation effects. OFDM is a promising technique to combat the adverse effects of ISI, even for delay spreads that are relatively large compared with signal duration. OFDM is a form of multicarrier transmission, in which symbol periods are relatively large, and a guard interval is typically used between successive OFDM symbols. When OFDM systems operate in a burst mode, rapid and accurate synchronization for symbol frames is desirable to achieve the potential performance benefits of OFDM systems. Frame synchronization or timing synchronization directly affects performance of OFDM systems, such as those specified by the IEEE 802.11 a and HIPERLAN/2 standards.

Existing techniques use repeated synchronization signals added at the beginning of radio packets transmitted in OFDM systems. This technique is used, for example, in OFDM systems that conform with IEEE 802.11a specifications. The PLCP preamble field is used for synchronization.

FIG. 1 schematically represents the structure of the preamble that proceeds each OFDM packet, in which t₁ to t₁₀ denote short training symbols and T₁ and T₂ denote long training symbols. The SIGNAL field and DATA field follow the PLCP preamble. This preamble assists with start-of-packet detection, automatic gain control, symbol timing (or frame synchronization), frequency estimation, and channel estimation. Ten short preamble symbols are used to perform coarse frequency estimation, perform automatic gain control, and frame synchronization.

Other techniques are also proposed for frequency offset compensation and timing synchronization techniques for OFDM systems. For packet transmission, however, accurate synchronization requires obtaining an average over a relatively large (for example, greater than ten) number of OFDM symbols to attain a distinct correlation peak and a reasonable signal-to-noise ratio (SNR). These symbols, of course, undesirably require a longer transmission time. For high-rate packet transmission, synchronization time is desirably as short as possible, and is preferably achieved over only a few OFDM symbols. To this end, the ten short preambles represented in FIG. 1 are used, in which the receiver knows the data content. That is, these preamble symbols are predetermined.

In view of the above observations, a need clearly exists for an improved manner of synchronising transmitters and receivers in multicarrier modulation systems.

### SUMMARY

A method for determining a frame synchronization result in a multicarrier modulation system includes a step of calculating a first frame synchronization result based upon symbols received in a receiver of the multicarrier modulation system. Then a second frame synchronization result is calculated based upon symbols received in a receiver of the multicarrier modulation system. A weighted frame synchronization result is then calculated based upon a complementary weighted summation of the first frame synchronization result and the second frame synchronization result.

A software program, recorded on a medium, for determining frame synchronization parameters in a multicarrier modulation system includes a first set of instructions that calculate a first frame synchronization result based upon symbols received in a receiver of the multicarrier modulation system. A second set of instructions are used to calculate a second frame synchronization result based upon symbols received in a receiver of the multicarrier modulation system. A third set of instructions are used to calculate a weighted frame synchronization result based upon a complementary weighted summation of the first frame synchronization result and the second frame synchronization result.

An algorithmic technique for frame synchronization in OFDM systems involves calculating a frame synchronization result as a complementary weighted summation of individual frame synchronization results respectively determined using (i) a matched filtered technique, and (ii) an autocorrelation technique.

### DESCRIPTION OF DRAWINGS

FIG. 1 is a timing diagram of OFDM symbols involving a sequence of preamble training symbols.

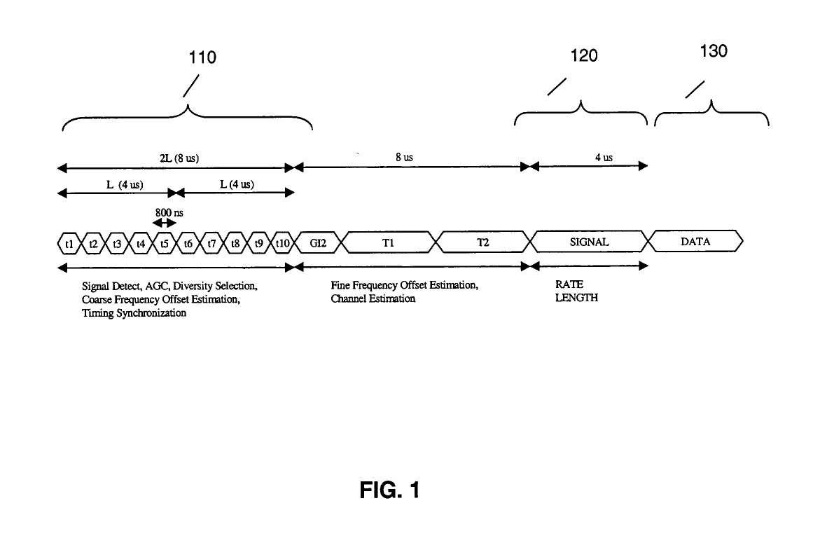

FIG. 2 is a schematic representation, in block diagram form, of a matched filter technique for determining frame synchronization in OFDM systems.

FIG. 3 is a flowchart representing steps involved in the matched filter technique described with reference to FIG. 2.

FIG. 4 is a schematic representation, in block diagram form, of an autocorrelation technique for determining frame synchronization in OFDM systems.

FIG. 5 is a flowchart representing steps involved in the autocorrelation technique described with reference to FIG. 4.

FIG. 6 is a flowchart representing steps involved in a described technique for determining frame synchronization in OFDM systems.

FIG. 7 is a performance graph, for different values of α, of the described technique in the presence of additive white Gaussian noise. Synchronization failure rate is represented on a logarithmic scale against bit energy-to-noise ratio (Eb/No) on a linear scale in decibels.

FIG. 8 is a performance graph, for different parameters of α, of the described technique in the presence of additive white Gaussian noise. Bit error rate is represented on a logarithmic scale against bit energy-to-noise ratio (Eb/No) on a linear scale in decibels.

FIG. 9 is a performance graph, for different parameters of α, of the described technique in a fading channel. Bit error rate if represented on a logarithmic scale against bit energy-to-noise ratio (Eb/No) on a linear scale in decibels.

### DETAILED DESCRIPTION

A technique is described herein for frame synchronization in OFDM systems. This described technique is effectively a hybrid of a matched filter technique and an autocorrelation technique, both also used for frame synchronization purposes. Both of these two techniques (that is, the matched filter technique and the autocorrelation technique) are described herein under correspondingly entitled subsections.

The autocorrelation technique involves dividing the ten short preamble training symbols into two streams (t₁ to t₅, and t₆ to t₁₀). The values in these two streams are the same. That is, the ten short preamble training symbols consist of a signal, repeated twice.

Matched Filter Technique

The matched filter technique for frame synchronization involves computing a k-th correlation between received signal and training signal symbols, received in the receiver. This correlation is computed in accordance with Equation (1) below.

$${R}_{k} = \vert {\sum }_{i = 0}^{2 L - 1} {x}_{k + i} {s}_{i}^{*} \vert \qquad ( 1 )$$

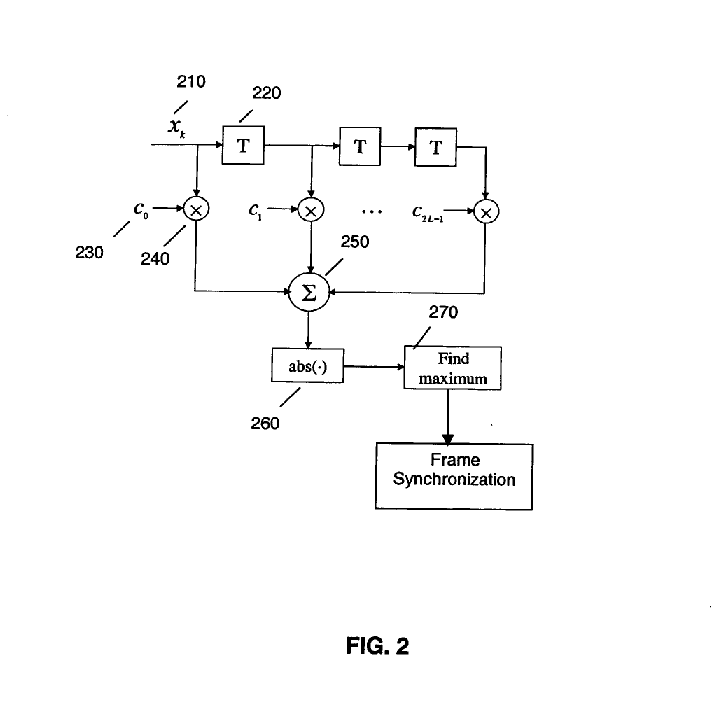

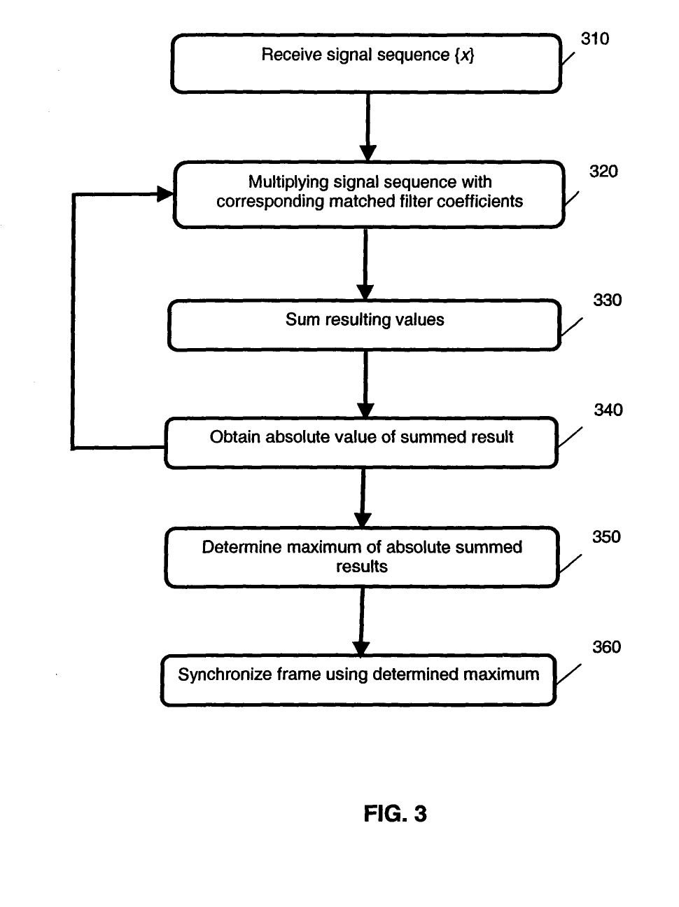

In Equation 1, {xᵢ} represents the received signal sequence, and {s₀, sᵢ . . . s_{2L-1}} represents the ten short preamble symbols. Equation 1 is described below with reference to the block diagram of FIG. 2 and the flowchart of FIG. 3. In summary, the framed synchronization parameter is Rₖ, which represents the absolute value of a summation of multiplied data symbols and training preamble symbols.

FIG. 2 schematically represents, in block diagram form, functional blocks that perform the matched filter calculation of Equation (1). Input data symbols xₖ 210 are multiplied with matched filter coefficients Cᵢ 230, using multiplication block 240. A series of delay blocks T 220 represent a sampling interval of OFDM system. The matched filter coefficients Cᵢ 230 are respectively complex conjugates of the predetermined preamble training signals symbols Sᵢ.

The result of each individual multiplication operation is summed by using summation block 250 and the resulting value is passed to an absolute value block 260. The resulting value is then passed to a maximum value block 270, which determines the maximum value of the inputs provided to this block 270 during the frame synchronization procedure.

The maximum value that is determined by the maximum value block 270 determines the frame synchronization that is consequently achieved. In effect, the frame synchronization is obtained from correlation peaks in the matched filter output signal.

FIG. 3 flowcharts the above-described steps in overview. In step 310, the signal sequence {xᵢ} is received. In step 320, this signal sequence is multiplied with corresponding matched filter coefficients. In step 330, the resulting values are summed. In step 340, an absolute value of the summed result is obtained. In step 350, the maximum of this absolute summed result is determined, and from this result frame synchronization is determined in step 360.

Further details concerning the matched filter technique can be obtained from Richard van Nee and Ramjee Prasad, OFDM Wireless Multimedia Communication, Artech House, Boston, 2000, Chapter 4, Section 4.6. The content of this section of this reference is herein incorporated by reference.

Autocorrelation Technique

The autocorrelation technique involves computing the k-th autocorrelation of the received signal symbols received in the receiver, in accordance with Equation (2) below.

$${R}_{k} = \vert {\sum }_{i = 0}^{L - 1} {x}_{k + L + i} {x}_{k + i}^{*} \vert \qquad ( 2 )$$

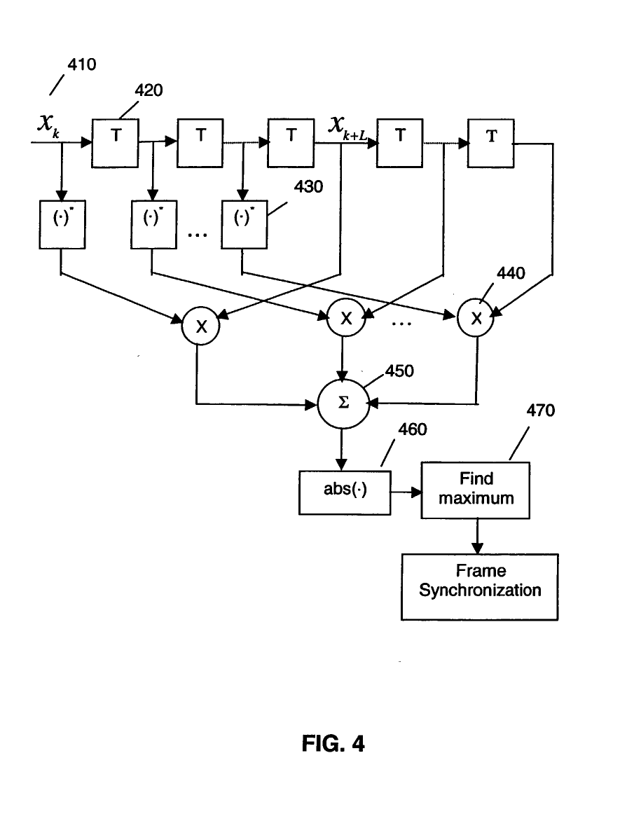

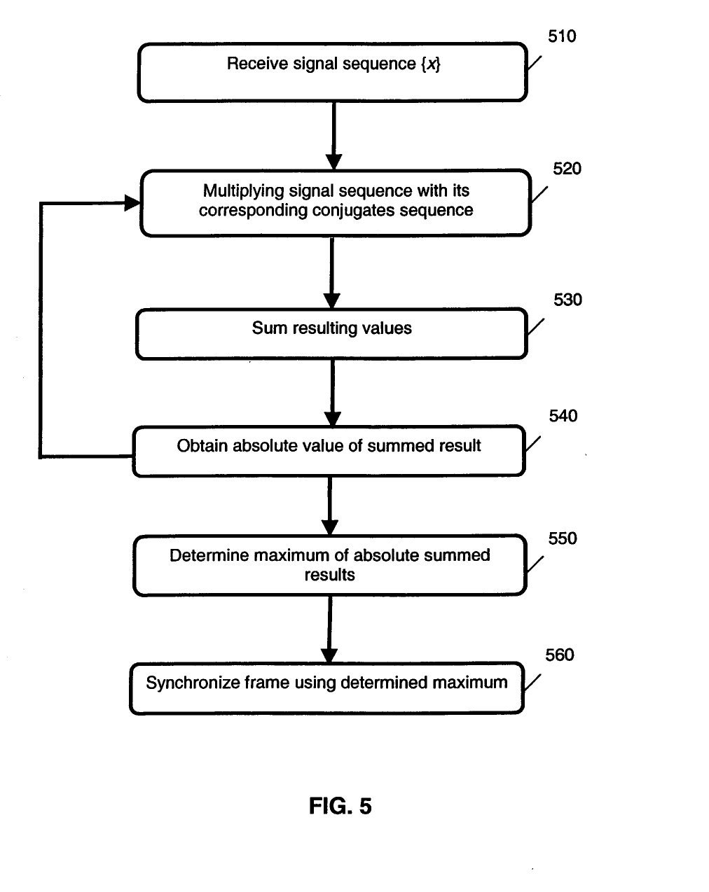

Frame synchronization is obtained from the autocorrelation peaks computed using Equation 2. The computational steps involved in Equation 2 are described herein with reference to the block diagram of FIG. 4, and the flowchart of FIG. 5.

The autocorrelation technique for frame synchronization involves autocorrelating the incoming received signal sequence (xᵢ). As this signal sequence repeats a pattern of five training preamble symbols, the autocorrelation result indicates a peak, which can be used for timing or synchronisation purposes.

FIG. 4 schematically represents, in block diagram form, functional blocks that preform the autocorrelation technique. Input data symbols xₖ 410 are, in one branch, passed through a succession of delayed blocks T 420 and, in another branch, transformed to their complex conjugate by conjugate blocks 430. A series of multiplication operation is performed by multiplication blocks 440, prior to a summation operation performed by summation block 450. An absolute value of the result is obtained by absolute value block 460, and a maximum is determining using maximum value block 470. The frame synchronisation results from this determined maximum.

FIG. 5 flowcharts the above-described steps in overview. In step 510, a signal sequence {x₁} is received. In step 520, this received signal sequence is multiplied with its corresponding conjugate sequence. In step 530, the result in value is a summed, and in step 540 the absolute value of the summed result is obtained. Steps 520 to 540 are repeated for each delayed value with the received signal sequence, as indicated in FIG. 4. In step 550, a maximum of the absolute sum results is determined. In step 560, a frame can be synchronised using the determined maximum synchronisation result.

Further details concerning the autocorrelation technique can be obtained from (i) T. Onizawa, M. Mizoguchi, M. Morikura and T. Tanaka, “A Fast Synchronization Scheme of OFDM Signals for High-rate Wireless LAN”, IEICE Transactions on Communications, Vol. E82-B, No. 2, pp. 455-463, February 1999 (ii) T. M. Schmidl and D. C. Cox, “Robust Frequency and Timing Synchronization for OFDM”, IEEE Transactions on Communications, Vol. 45, pp. 1613-1621, December 1997. The contents of these two references are herein incorporated by reference.

As noted above, the ten short preamble training symbols consists of a sequence of five symbols that are repeated twice.

Implementation of Algorithmic Technique

The matched filter technique, described above, and the autocorrelation technique do not operate optimally in the presence of additive white Gaussian noise and multipath fading, or for multipath fading channels, especially if there is a carrier frequency offset between transmitter and receiver. The described frame synchronization technique is essentially a hybrid of the two above-described techniques. The described technique involves a complementary weighting of these two frame synchronization parameters Rₖ obtained using these two respective techniques. The relevant computation proceeds in accordance with Equation 3 below.

$${R}_{k} = α \vert {\sum }_{i = 0}^{2 L - 1} {x}_{k + i} {s}_{i}^{*} \vert + ( 1 - α ) \vert {\sum }_{i = 0}^{L - 1} {x}_{k + L + i} {x}_{k + i}^{*} \vert \qquad ( 3 )$$

In Equation 3, αε(0,1). If α equals one, Equation 3 reverts to the matched filter calculation presented above as Equation 1. If, instead, α equals zero, Equation 3 would revert to the autocorrelation technique represented as Equation 2.

The calculation of Equation 3 draws upon procedures described with respect to the matched filtered technique and the autocorrelation technique, both described above.

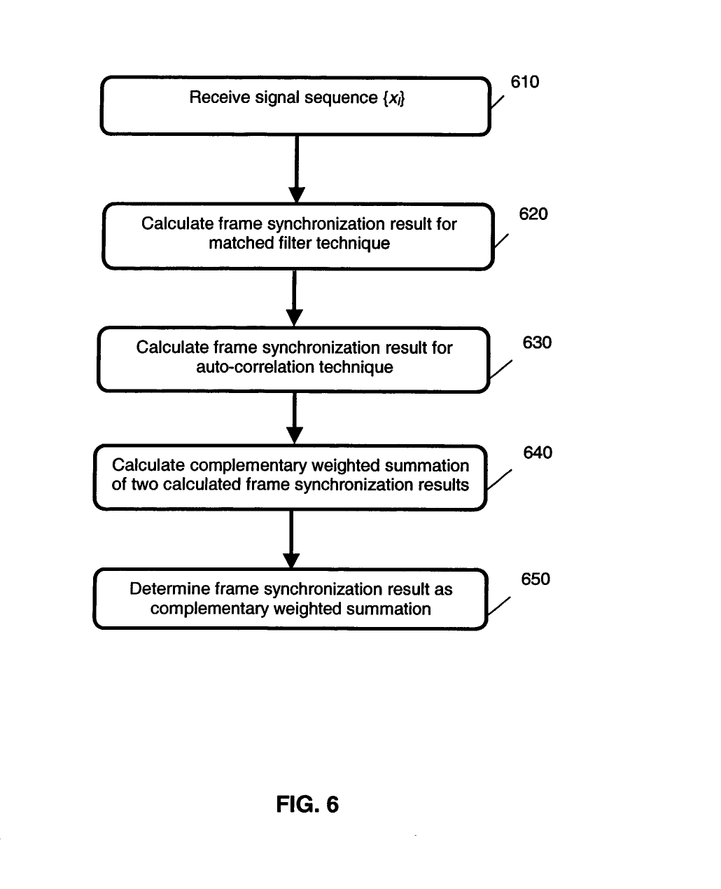

FIG. 6 flowchart steps involved in the procedure of the described frame synchronization technique. In step 610 the signal sequence {xᵢ} is received. In step 620, the frame synchronization result using the matched filter technique is calculated. In step 630, the frame synchronization result using the autocorrelation technique is calculated. In step 640, the complementary weighted summation of these two calculated frames synchronization results is calculated, as per Equation (3). In step 650, a weighted frame synchronization result is provided as this complementary weighed summation.

A computational techniques described above with reference to FIG. 6, and the foregoing description of the matched filter technique and the autocorrelation technique are implemented as follows.

Performance Results

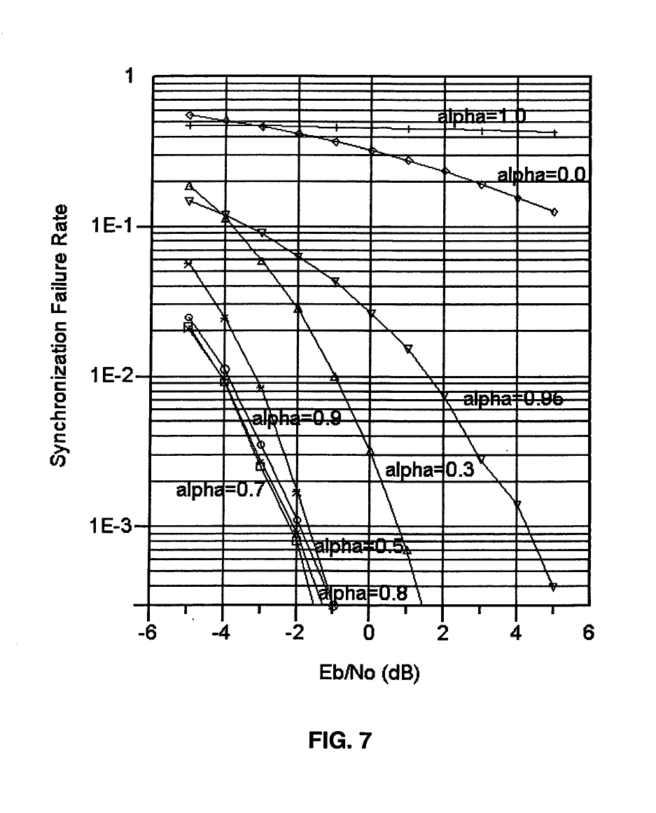

FIG. 7 graphs the best synchronization failure rate in a channel affected by additive white Gaussian noise (AWGN). These results were generated based upon an assumption of a 36 Mbps data rate, a transmitted packet length of 128 bytes, a carrier frequency offset between transmitted and receiver of 70 kHz.

FIG. 7 demonstrates that the matched filter technique (α=1) and the autocorrelation technique (α=0) have relatively high synchronization failure rates compared to the described frame synchronization technique. The synchronization failure rate becomes smaller as α moves away from both zero and one, particularly when α moves away from 1.0.

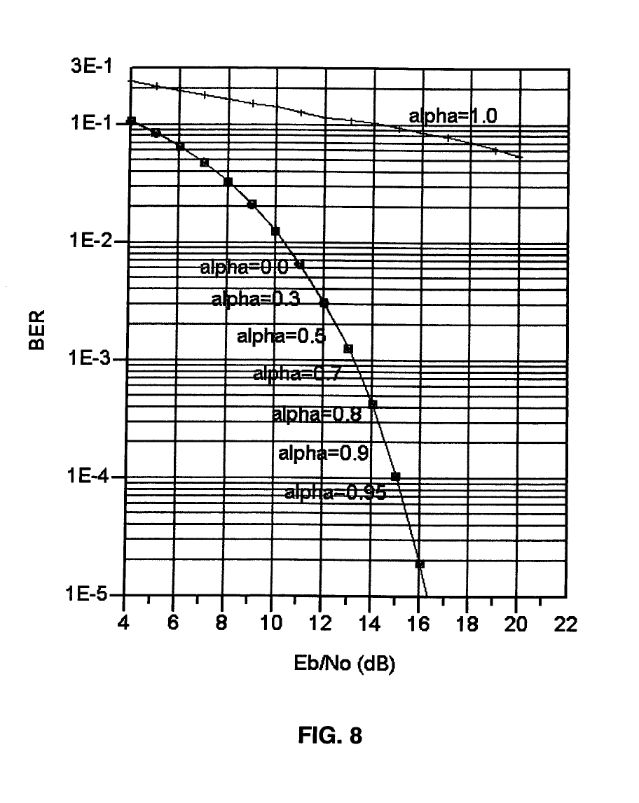

FIG. 8 graphs raw (that is, uncoded, without channel coding/decoding) bit error rate (BER) in an AWGN channel. These results were generated using the same assumptions made for FIG. 7.

FIG. 8 indicates that the matched filter technique (α=1) has relatively poor BER performance due to poor frame synchronization. The autocorrelation technique (α=1), however, has the same BER performance as the described frame synchronization technique (with αε(0,1)) in an AWGN channel.

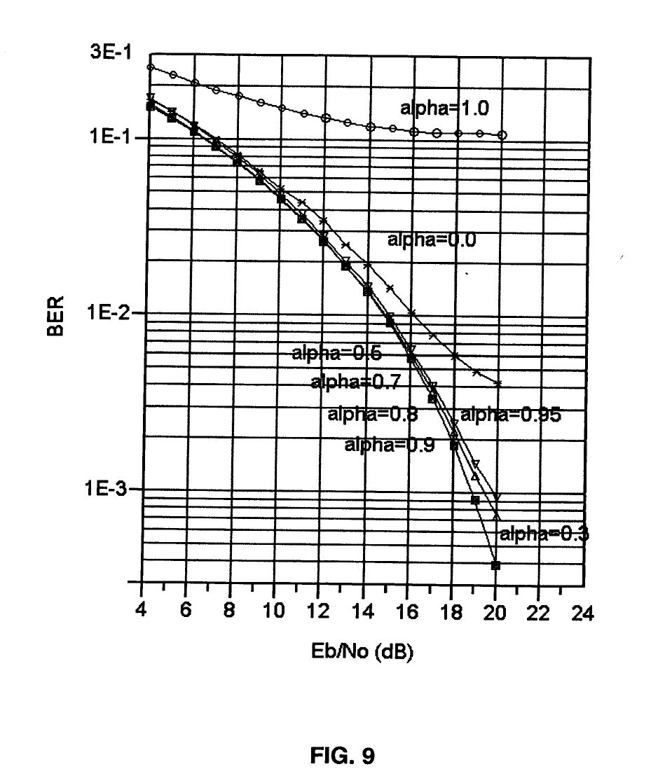

FIG. 9 graphs the raw BER in a fading channel, using the same assumptions made for both FIGS. 7 and 8. FIG. 9 indicates that the BER performance of the matched filter technique (α=1) is relatively poor, and the autocorrelation technique (α=0) is slightly better than that of the matched filter technique (α=1). The BER performance of the described frame synchronization algorithm improves as α increases. The BER performance, however, is poor under the autocorrelation technique, for which α=0.

The described frame synchorization technique advantageously operates in AWGN and fading channels, irrespective of whether there is carrier frequency offset between transmitter and receiver. Based on empirically observed performance results, α is advantageously chosen to be between 0.5 and 0.9. That is, in set notation, αε[0.5, 0.9].

A technique for frame synchronization has been described herein for OFDM systems having repeated preamble training symbols. The described techniques can also be used using the two long preambles specified in IEEE 802.11a and HYPERLAN/2. Accordingly, the described techniques can be used in IEEE 802.11a, HYPERLAN/2 and MMAC systems. System performance, at least in respect of synchronization failure rate and bit error rate is improved compared and is at least equal to that achievable using a matched filter technique or an autocorrelation technique.

Various alterations and modifications can be made to the detector designs and associated techniques described herein, as would be apparent to one skilled in the relevant art.

1. A method for determining a frame synchronization result in a multicarrier modulation system, comprising:
calculating a first frame synchronization result based upon symbols received in a receiver of the multicarrier modulation system;
calculating a second frame synchronization result based upon symbols received in a receiver of the multicarrier modulation system; and
calculating a weighted frame synchronization result based upon a complementary weighted summation of the first frame synchronization result and the second frame synchronization result.

2. The method as claimed in claim 1, wherein the first frame synchronization result is based upon a matched filter procedure.

3. The method as claimed in claim 1, wherein the second frame synchronization result is based upon an autocorrelation procedure.

4. The method as claimed in claim 1, wherein determining the complementary weighted summation involves respective weights ((α) and (1-α)) that sum to unity.

5. The method as claimed in claim 4, wherein α is between approximately 0.5 and 0.9.

6. The method as claimed in claim 1, wherein the first frame synchronization result is based upon a matched filter procedure which is complementarily weighted between approximately 50% and 90%, and the second frame synchronization result is based upon an autocorrelation procedure which is complementarily weighted between approximately 50% and 10%.

7. The method as claimed in claim 2, wherein the matched filter procedure comprises the step of determining a correlation peak in an output signal of a matched filter when predetermined preamble training symbols are received.

8. The method as claimed in claim 7, wherein the matched filter coefficients of the matched filter are each respectively complex conjugates of the predetermined preamble training symbols.

9. The method as claimed in claim 3, wherein the autocorrelation procedure comprises autocorrelating two streams of identical preamble training symbols.

10. Coded instructions, recorded on a medium, for determining frame synchronization parameters in a multicarrier modulation system, comprising:
a first set of instructions that calculate a first frame synchronization result based upon symbols received in a receiver of the multicarrier modulation system;
a second set of instructions that calculate a second frame synchronization result based upon symbols received in a receiver of the multicarrier modulation system; and
a third set of instructions that calculate a weighted frame synchronization result based upon a complementary weighted summation of the first frame synchronization result and the second frame synchronization result.

11. Coded instructions as claimed in claim 10, wherein the first frame synchronization result is based upon a matched filter procedure.

12. Coded instructions as claimed in claim 10, wherein the second frame synchronization result is based upon an autocorrelation procedure.

13. Coded instructions as claimed in claim 10, wherein the complementary weighted summation involves respective weights ((α) and (1-α)) that sum to unity.

14. Coded instructions as claimed in claim 13, wherein α is between approximately 0.5 and 0.9.

15. Coded instructions as claimed in claim 10, wherein the first frame synchronization result is based upon a matched filter procedure which is complementary weighted between approximately 50% and 90%, and the second frame synchronization result is based upon an autocorrelation procedure, which is complementarily weighted between approximately 50% and 10%.

16. Coded instructions as claimed in claim 11, wherein the matched filter procedure comprises the step of determining a correlation peak in an output signal of a matched filter when predetermined preamble training symbols are received.

17. Coded instructions as claimed in claim 16, wherein the matched filter coefficients of the matched filter are each respectively complex conjugates of the predetermined preamble training symbols.

18. Coded instructions as claimed in claim 12, wherein the autocorrelation procedure comprises the step of autocorrelating two streams of identical preamble training symbols.

19. A multicarrier modulation receiver which determines a frame synchronization result, the receiver comprising:
means for calculating a first frame synchronization result based upon symbols received in a receiver of the multicarrier modulation system;
means for calculating a second frame synchronization result based upon symbols received in a receiver of the multicarrier modulation system; and
means for calculating a weighted frame synchronization result based upon a complementary weighted summation of the first frame synchronization result and the second frame synchronization result.

20. The receiver as claimed in claim 19, wherein the first frame synchronization result is based upon a matched filter procedure.

21. The receiver as claimed in claim 19, wherein the second frame synchronization result is based upon an autocorrelation procedure.

22. The receiver as claimed in claim 19, wherein the complementary weighted summation involves respective weights ((α) and (1-α)) that sum to unity.

23. The receiver as claimed in claim 22, wherein α is between approximately 0.5 and 0.9.

24. The receiver as claimed in claim 19, wherein the first frame synchronization result is based upon a matched filter procedure which is complementary weighted between approximately 50% and 90%, and the second frame synchronization result is based upon an autocorrelation procedure, which is complementarily weighted between approximately 50% and 10%.

25. The receiver as claimed in claim 20, wherein the matched filter procedure comprises the step of determining a correlation peak in an output signal of a matched filter when predetermined preamble training symbols are received.

26. The receiver as claimed in claim 25, wherein the matched filter coefficients of the matched filter are each respectively complex conjugates of the predetermined preamble training symbols.

27. The receiver as claimed in claim 21, wherein the autocorrelation procedure comprises the step of autocorrelating two streams of identical preamble training symbols.
